(19) United States
(12) Patent Application Publication
(10) Pub. No.: US 2007/0102449 A1
(43) Pub. Date: May 10, 2007

(54) Anti-foreign object structure for a liquid container pump

(75) Inventor: Kun-Lung Tseng, Taichung Hsien (TW)

Correspondence Address: EGBERT LAW OFFICES, 412 MAIN STREET, 7TH FLOOR, HOUSTON, TX, 77002, US

(73) Assignee: Living Fountain Plastic Industrial Co., Ltd., Dali City (TW)

(21) Appl. No.: 11/270,197

(22) Filed: Nov. 10, 2005

(51) Int. Cl. B67D 5/00; B67B 5/00; B67D 5/40

(52) U.S. Cl. 222/153.13; 222/153.02; 222/384

(57) ABSTRACT

The structure that can keep a foreign object from coming into the container for the pump of the liquid container is focused on solving the dust accumulated inside the container before being sold. An anti-lock device is placed between the pump and the tip of the bottle, which includes an upper stopper, lower stopper, and a pre-snap rib. The upper stopper has a limit stopper that is placed at the end of the outlet tube of the pump, and the lower stopper is placed on the opening of the bottle. The pre-snap rib is placed between the upper and lower stopper. An extension part is placed on the upper stopper that extends to the outlet of the outlet tube, and a sealable lid is placed at the end of the extension part that can seal the outlet of the outlet tube.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a structure for a liquid container pump, and more particularly to a pump with anti-lock device, and an extension part and sealable lid that can seal the outlet of the outlet tube, and keep the foreign object from coming in.

### BACKGROUND OF THE INVENTION

There are many products with liquid container (such as lotion bottle) on the market today, and its pump stays sealed and down before it is sold, and the consumer can just turn the pump to an angle for the pump to pop up when the consumer desires to use. The consumers sometime turn the pump mentioned above purposely or not purposely when they are looking at the products in the supermarket, and cause the pump to pop up and ready to use. Maybe the consumers push the pump down so that it shows that is unopened. Except, if the pump on the same liquid container has been opened by the consumers mistakenly repeatedly, the lotion inside may be squeezed out, and the quality of the product may be affected. Therefore, the inventor has developed a structure that can prevent the pump of the liquid container being opened mistakenly before it is sold. It primarily includes an upper stopper and a lower stopper, and the upper stopper is used to restrict the pump of the liquid container, and the lower stopper is used to position the opening of the bottle of the liquid container, and a pre-snap rib is placed between the upper and the lower stoppers.

By this design, the pump would not turn if the consumer desires to turn the pump with regular forces because the pump is restricted by the pre-snap rib, however, when the consumer purchases the product, the pre-snap rib may be broken by stronger force, and the pump can be turned successfully. In addition to the pump being opened mistakenly mentioned above, the application of the conventional structure of this liquid container still has the following problems on the outlet tube of its pump: the outlet tube of the pump has an open tube opening under the regular circumstances, and this outlet tube is usually designed like a horizontal protruding state, therefore, the chances of some ill-intentioned customers sticking foreign objects inside increases, and causes the foreign objects to accumulate dust inside the outlet tube, and seriously affects the product's original quality and reputation.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The present invention mainly uses the upper stopper of the anti-lock device for the liquid container and extension part that extends to the outlet of the outlet tube, and places a sealable lid at the end of the extension part, which seals the outlet of the outlet tube. It can prevent foreign objects from coming into the container from the outlet 114 of the outlet tube 11 on top of keeping it from being opened with the anti-lock device. It further protects the quality of the liquid container and its reputation.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows the assembled perspective view of the preferred embodiment of the present invention.

FIG. 2 shows the assembled sectional view of the preferred embodiment of the present invention.

FIG. 3 shows the perspective view of the preferred embodiment of the anti-lock device and sealable lid of the present invention.

FIG. 4 shows the perspective view of another preferred embodiment of the connecting part of the lower stopper of the anti-lock device of the present invention.

FIG. 5 shows the perspective view of another preferred embodiment of the limit stopper of the upper stopper of the anti-lock device of the present invention.

FIG. 6 shows the sectional view of the limit stopper of the upper stopper disclosed above in FIG. 5.

FIG. 7 shows the perspective view of another preferred embodiment of the sealable lid of the present invention.

FIG. 8 shows the sectional view of the sealable lid disclosed in FIG. 7.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

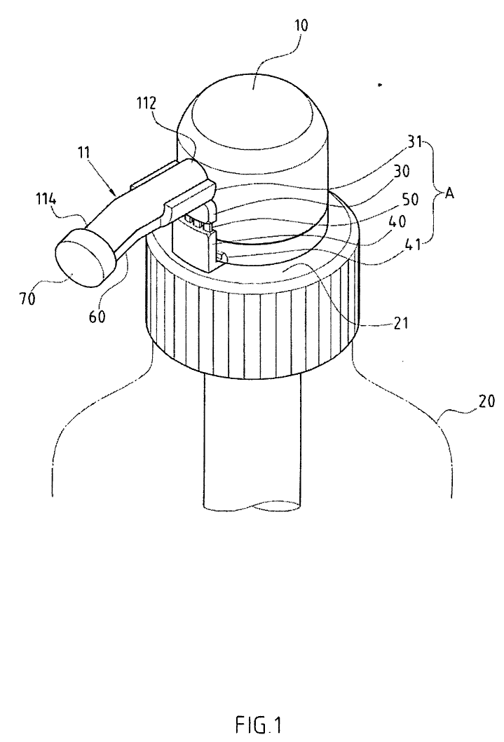

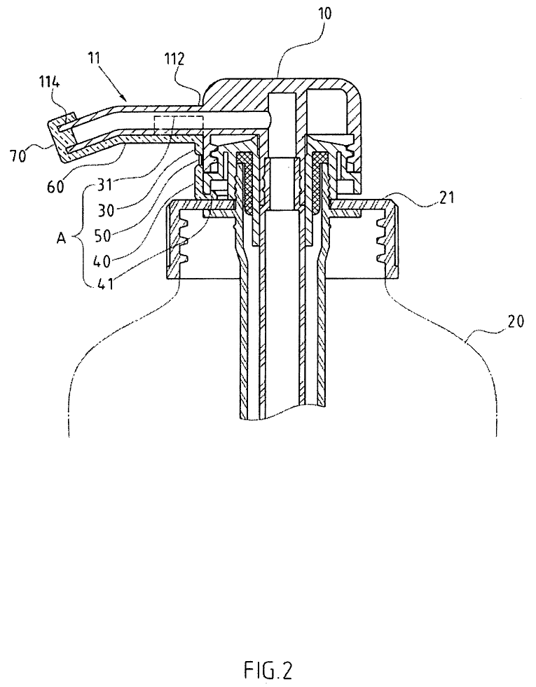

As shown in FIGS. 1-3, there is a preferred embodiment of the anti-foreign object structure for a liquid container pumps.

An anti-lock device A is placed between the pump 10 and the tip 21 of the container bottle, and the anti-lick device A, including an upper stopper 30 and a lower stopper 40. Among them, the upper stopper 30 has a limit stopper 31 that is placed at the end 112 of the outlet tube 11 of the pump 10, and the lower stopper 40 has a connecting part 41 that can be placed on the tip 21 of the container bottle 20, and a pre-snap rib 50 is placed between the upper and lower stopper 30 40.

An extension part 60 has a pre-designated area (it is the front end of the limit stopper 31 in the present invention) that is connected to the upper stopper 30 mentioned above, and the end of the extension part 60 extends toward the outlet 114 of the outlet tube 11.

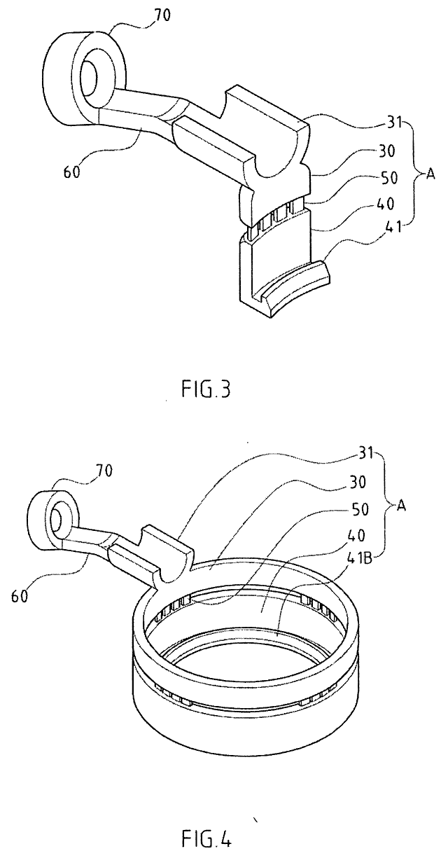

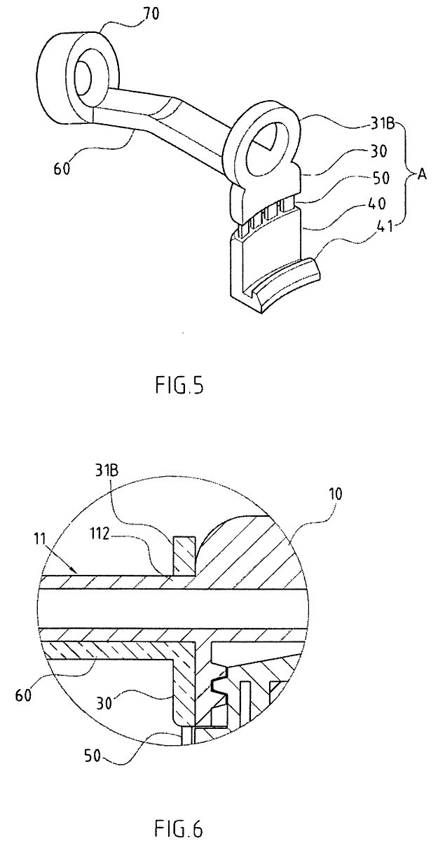

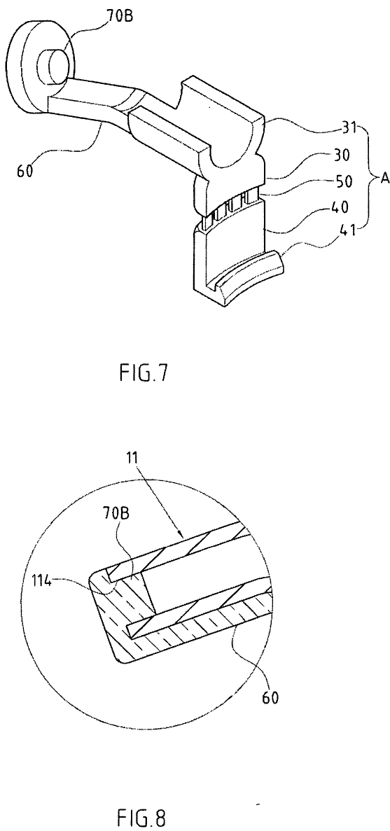

A sealable lid 70 is placed at the end of the extension part 60 mentioned above, and the shape of the sealable lid 70 can seal the outlet 115 of the outlet tube 11 and to keep the foreign objects from coming in. The example of the sealable lid 70 is presented as shown in FIG. 3, and can be a cover, which can cover the outside of the outlet 114 of the outlet tube 11. Also, the sealable lid 70B as shown in FIGS. 7 and 8 can be a depository style that can be deposited inside the outlet 114 of the outlet tube 11. Under the regular circumstances, the sealable lid 70 can connect to the upper stopper through extension part 60 and create positioning effect, therefore, it can not be opened, unless the pump 10 is turned forcefully and break the pre-snap rib 50. When the upper stopper 30 and the lower stopper 40 is broken off, the sealable lid 70 can be released, and the user may open it successfully, and open the outlet 114 of the outlet tube 11 for use.

Among them, the limit stopper 31 of the upper stopper 30 is shown as FIG. 3, which is a C-shaped gutter that restricts the outlet tube 111 by clapping. Also, the limit stopper 31B is shown in FIG. 5, which is a through hole type that restrict the outlet tube 11 by going through it.

Moreover, the connecting part 41 of the lower stopper 40 is shown in FIG. 3, which is a plate with wide that is only on the partial area of the tip 21 of the container bottle 20. Also, the connecting part 41B shown in FIG. 4 is a ring shape device that surround the tip 21 of the container bottle 20.

I claim:

1. An anti-foreign object structure for a liquid container pump of a container bottle, the structure comprising:
an anti-lock device placed between the pump and a tip of the container bottle, said anti-lock device being comprised of an upper stopper, a lower stopper, and a pre-snap rib, said upper stopper having a limit stopper placed at an end of an outlet tube of the liquid container pump, said lower stopper having a connecting part placed on an opening of the container bottle, said pre-snap rib being placed between the upper and lower stoppers;
an extension part connected to said upper stopper, an end of the extension part extending toward the outlet of the outlet tube; and
a sealable lid placed at the end of the extension part, a shape of the sealable lid sealingly engaging the outlet of the outlet tube.

2. The structure defined in claim 1, wherein said limit stopper of the upper stopper is comprised of a C-shaped gutter type.

3. The structure defined in claim 1, wherein said limit stopper of the upper stopper is comprised of through holes.

4. The structure defined in claim 1, wherein the connecting part of the lower stopper is comprised of a plate.

5. The structure defined in claim 1, wherein the connecting part of the lower stopper is comprised of a ring like device.

6. The structure defined in claim 1, wherein said sealable lid is comprised of a cover.

7. The structure defined in claim 1, wherein said sealable lid is comprised of a depository.
